(19) United States
(12) Patent Application Publication
(10) Pub. No.: US 2018/0268243 A1
(43) Pub. Date: Sep. 20, 2018

(54) OBTAINING A NETWORK ADDRESS BASED ON AN IDENTIFIER

(71) Applicant: HEWLETT PACKARD ENTERPRISE DEVELOPMENT LP, Houston, TX (US)

(72) Inventor: David L. Santos, Roseville, CA (US)

(21) Appl. No.: 15/542,322

(22) PCT Filed: Jan. 9, 2015
(86) PCT No.: PCT/US2015/010833

§ 371 Date: Jul. 7, 2017

(51) Int. Cl. G06K 9/32; G06K 9/18; H04L 29/12; H04W 8/26

(52) U.S. Cl. CPC G06K 9/3258; G06K 9/183; H04W 48/17; H04L 61/2015; H04W 8/26; H04L 61/103

(57) ABSTRACT

Examples disclosed herein relate, among other things, to wirelessly detecting an identifier of a network device connected to a network, accessing the network to obtain a network address associated with the network device based on the identifier, and communicating with the network device through the network using the network address.

### BACKGROUND

Today, many electronic devices such as printers, scanners, copiers, all-in-one systems, etc., are connected to a network and are accessed and used by users remotely. In addition to regular use, electronic devices often need to be monitored for problems, reconfigured, or otherwise managed. Managing network devices may be performed in either “out-of-band” or “in-band” fashion. In out-of-band management, the device is managed through a dedicated physical management port. In in-band management, the device is managed through a network to which it is connected.

### BRIEF DESCRIPTION OF THE DRAWINGS

The following detailed description references the drawings, wherein:

FIG. 1 is a block diagram of an example computing system;

FIG. 2 illustrates an example computing device and an example network device;

FIG. 3 illustrates another example computing device;

FIG. 4 illustrates another example computing device;

FIG. 5 shows a flowchart of an example method for finding a network device on a network; and

FIG. 6 is a block diagram of another example computing device.

### DETAILED DESCRIPTION

As discussed above, some network devices, such as devices that do not have a designated physical management port, may be managed through the network to which they are connected. In order to communicate with a device through a network, the device's network address (e.g., IP address) may be required. The network address may be assigned to a device when the device is first connected to the network or when it is subsequently disconnected from and reconnected to the network. In some cases, the network address may be assigned automatically, e.g., by a designated Dynamic Host Configuration Protocol (DHCP) server. In other cases, the network address may be manually assigned, e.g., by the network administrator.

The assigned network address may sometimes be retrieved by the user using the device's user interface. Some devices, however, may not have a display or may not be configured to show their network address through the user interface. Managing such devices may be problematic because, as mentioned above, the device's network address may be required in order to access it through the network. Thus, a technician attaching a new network device to the network may be unable to check its status or configure the device if the technician cannot ascertain the network address that was assigned to the device upon connection.

Examples disclosed herein describe, among other things, a computing device. The computing device may include, among other things, a detection engine to wirelessly detect an identifier of a network device communicatively coupled to a network. The computing device may also include a communication engine to access the network to obtain, based on the identifier, a network address associated with the network device, and to communicate with the network device through the network using the network address.

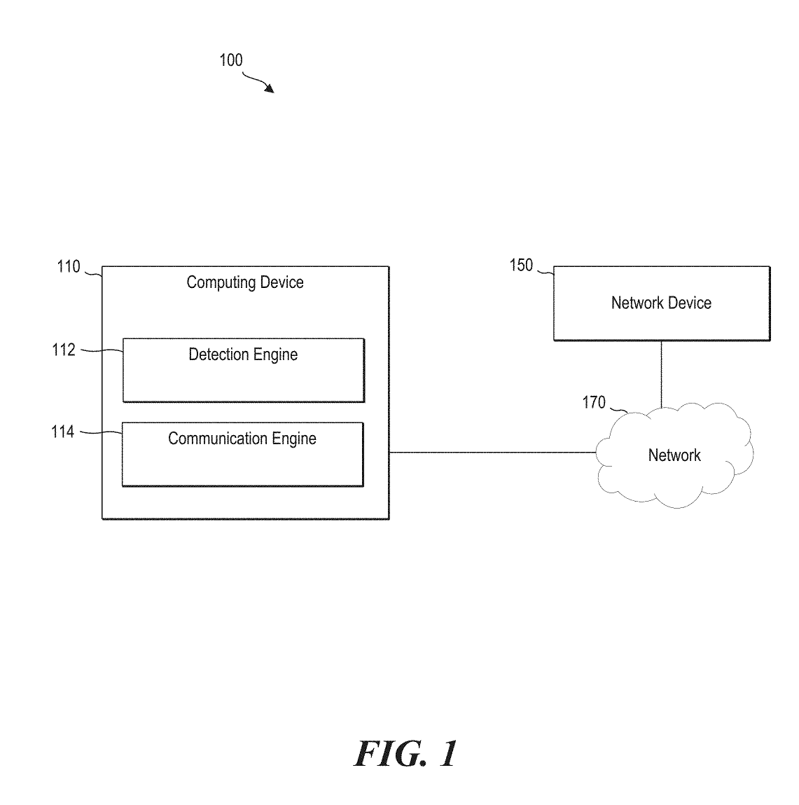

FIG. 1 is a block diagram of an example computing system 100. Computing system 100 may include a computing device 110, a network device 150, and a network 170. Network device 150 may be communicatively coupled to network 170, either wirelessly or via a cable. Computing device 110 may also be configured to connect to network 170, as further discussed below.

Network device 150 may include any electronic device or combination of electronic devices that can be communicatively coupled to a network (e.g., network 170). Such electronic devices may include, for example, printers, scanners, copiers, all-in-one systems, home appliances, servers, routers, desktop computers, laptops, tablet computers, TVs, smartphones, or any other type of electronic equipment. In some examples, network device 150 may not support out-of-band management, for example, due to lack of a dedicated physical management port, but may support in-band management. In some examples, the network address assigned to network device 150 may not be ascertainable through interfacing with the device via the user interface. For example, network device 150 may not have a display or may not be configured to show its assigned network address on the display.

Network 170 may be any combination of wired, wireless, wide-area, and local-area networks, and may include any number of hubs, routers, switches, cell towers or the like. Network 170 may be, for example, part of a cellular network, part of the Internet, part of an intranet and/or other type of network. As discussed above, network device 150 may be communicatively coupled to network 170 either wirelessly or via a cable, and upon connecting to network 170, network device 150 may be assigned (or associated with) a network address such as an IP address. In some examples, when network device 150 is disconnected and then reconnected to network 170 it may be assigned a new network address.

Computing device 110 may include any electronic device or a combination of electronic devices that can be communicatively coupled to a network (e.g., network 170). For example, computing device 110 may be a desktop computer, a laptop computer, a tablet, a smartphone, a cell phone, a digital camera, or any other electronic device or combination thereof. As illustrated in FIG. 1, computing device 110 may include a detection engine 112 and a communication engine 114. Detection engine 112 and communication engine 114 may each generally represent any combination of hardware and programming.

In some examples, detection engine 112 may be configured to detect and identify network device 150. Specifically, detection engine 112 may be configured to detect an identifier of network device 150 when computing device 110 is located in the vicinity of (e.g., within a predefined distance from) network device 150. An identifier of network device 150 may include any type of data (e.g., numerical, alphanumerical, graphical, etc.) that is associated with network device 150 and that identifies it (in some examples, uniquely) among other network devices communicatively coupled to network 170. For example, an identifier may be a Media Access Control (MAC) address, a serial number, a manufacturer name, a model number, or any combination of these or other types of information describing the device.

In some examples, detection engine 112 may detect the identifier of network device 150 wirelessly. This may include detection in visible light spectrum, infrared spectrum, radio-frequency (RF) spectrum, and so forth. In some examples, network device 150 may exchange its identifier with detection engine 112 using a radio-frequency identification (RFID) system.

In other examples, the identifier may appear (or be visually represented) on, at, or near network device 150. For example, the identifier may appear on a side of network device 150, on top of network device 150, or on any other face or surface of network device 150. The identifier may be written, inscribed, or imprinted on network device 150; it may appear on a label coupled to network device 150; or it may be otherwise visually present on, at, or near network device 150. The identifier may be represented using a number, an alphanumeric value, a barcode, a quick response (QR) code, or using any other method of representation.

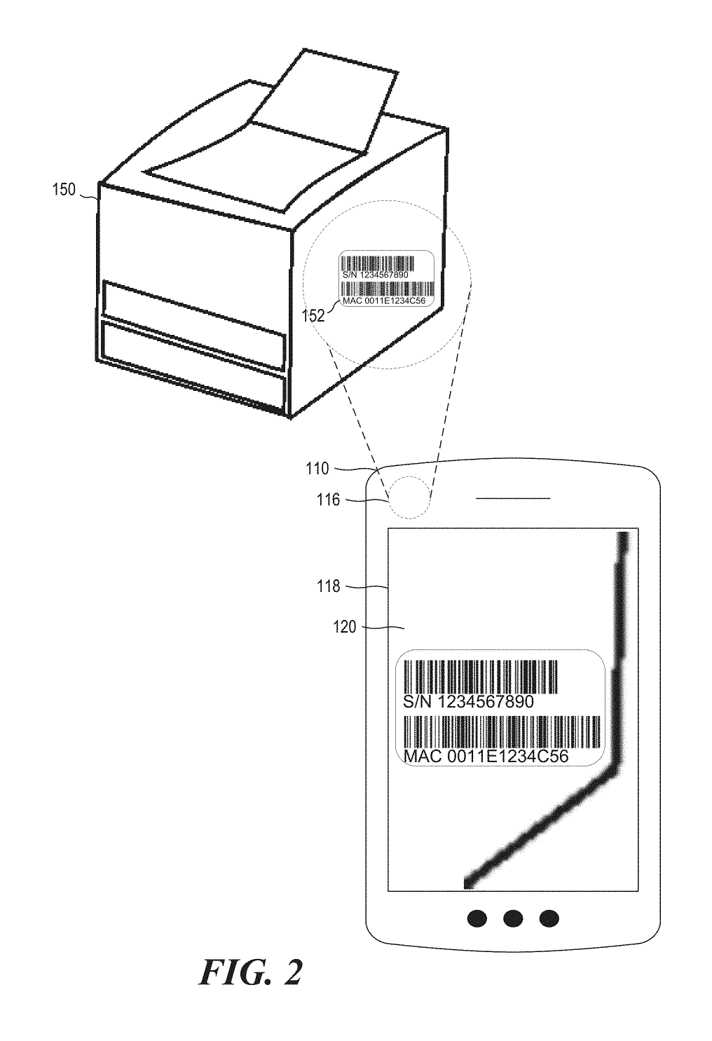

In these examples, computing device 110 may include a camera or an image sensor with which computing device 110 may capture an image of at least a portion of the network device 150 and/or its vicinity, such that the image includes the identifier of network device 150. For example, FIG. 2 illustrates a label 152 attached to an example network device 150. Label 152 includes two identifiers, a serial number and a MAC address, each represented by a barcode and an alphanumeric value. FIG. 2 also illustrates an example computing device 110 having, among other things, a back-facing camera 116 and a display 118. As illustrated in FIG. 2, the user may position computing device 110 such as to enable camera 116 to capture an image 120 that includes label 152. The captured image may be provided by camera 116 to display 118 and to detection engine 112.

Detection engine 112 may process image 120 to detect any identifiers present within the image. In some examples, detection engine 112 may use Optical Character Recognition (OCR) algorithms to detect and decode any characters, numbers or symbols present in the image. In some examples, engine 112 may use barcode detection algorithms and QR-code detection algorithms to detect and decode any barcodes or QR codes within the image. In the example of FIG. 2, based on image 120, detection 112 detects and decodes two identifiers of network device 150: a serial number “1234567890” and a MAC address “0011E1234C56.”

When at least one identifier is detected and decoded by detection engine 112, the identifier may be provided by detection engine 112 to communication engine 114. After obtaining the identifier, communication engine 114 may be configured to access network 170 (e.g., through any suitable means such as Wi-Fi, cellular network, satellite network, cable, etc.) and to obtain, based on the identifier, a network address associated with network device 150. Depending on the type of network 170 and the preferred communication protocol, a network address may be an IP address or any other type of address uniquely identifying network device 150 on network 170 and allowing other devices on network 170 to address and communicate with network device 150.

In some examples, in order to obtain the network address based on the identifier, communication engine 114 may send a query to a designated server, such as a DHCP server, of network 170. The query may include the identifier of network device 150, such as its MAC address. The designated server may be configured to send to communication engine 114 a query response that includes the network address (e.g., the IP address) associated with the identifier, and therefore, with network device 150.

Alternatively or additionally, communication engine 114 may send queries to a plurality of network addresses. For example, communication engine 114 may determine the range of all possible network addresses within network 170, and then send queries to all network addresses within that range, e.g., sequentially. In response to each query, communication engine 114 may receive either an error message or no message at all if no device on network 170 is associated with the specified network address, or a reply message containing an identifier associated with the network device associated with the particular network address. For example, the query may be a “ping” message sent over an Internet Control Message Protocol (ICMP) to a particular IP address, and the reply to such “ping” message may include the MAC address of a device associated with the IP address, if such device exists.

As another example, a query may include a Simple Network Management Protocol (SNMP) request sent to a particular IP address. As in the previous example, if the particular IP address is associated with a network device, engine 114 may receive in response to the request an SNMP reply containing one or more identifiers associated with that network device, for example, in the form of a Management Information Base (MIB) object. Otherwise, engine 114 may receive an error message.

After sending a query to a given network address and receiving a response other than an error message, communication engine 114 may compare one or more identifiers detected by detection engine 112 with one or more identifiers contained in the response. In some examples, if at least one of the identifiers obtained from detecting engine 112 matches at least one of the identifiers contained in the response, communication engine 114 may determine that the given network address is associated with network device 150.

After determining the network address assigned to network device 150, communication engine 114 may use the network address to communicate with network device 150. For example, communication engine 114 may receive from network device 150 information such as its identification information, status information, error messages, configuration data, supported capabilities, and so forth. Communication engine 114 may also send to network device 150, and/or to another device responsible for managing network device 150 or network 170, updated or additional information associated with network device 150. Additional information may include, for example, network device's 150 geographical location that may be obtained, for example, by computing device 110 using a Global Positioning System (GPS) module included therein or coupled thereto. In some examples, communication engine 114 may also communicate with network device 150 to reconfigure, control, or otherwise manage the device.

In some examples, some or all of the above-described functionality (e.g., detecting an identifier, decoding the identifier, accessing the network to obtain the network address, and communicating with the network device using the network address) may be performed automatically, without requiring any action or acknowledgement by the user. For example, when computing device 110 is brought (e.g., by a user) into the vicinity of network device 150 (and in some examples, when its camera 116 faces network device 150) computing device 110 may automatically (without any acknowledgement or other action by the user) detect and decode the identifier as described above, and then automatically access the network to determine the network address of network device 150 based on the identifier as described above. Furthermore, after obtaining the network address, computing device 110 may automatically communicate with network device 150 using the determined network address in order to obtain its information and present the obtained information to the user, e.g., on display 118.

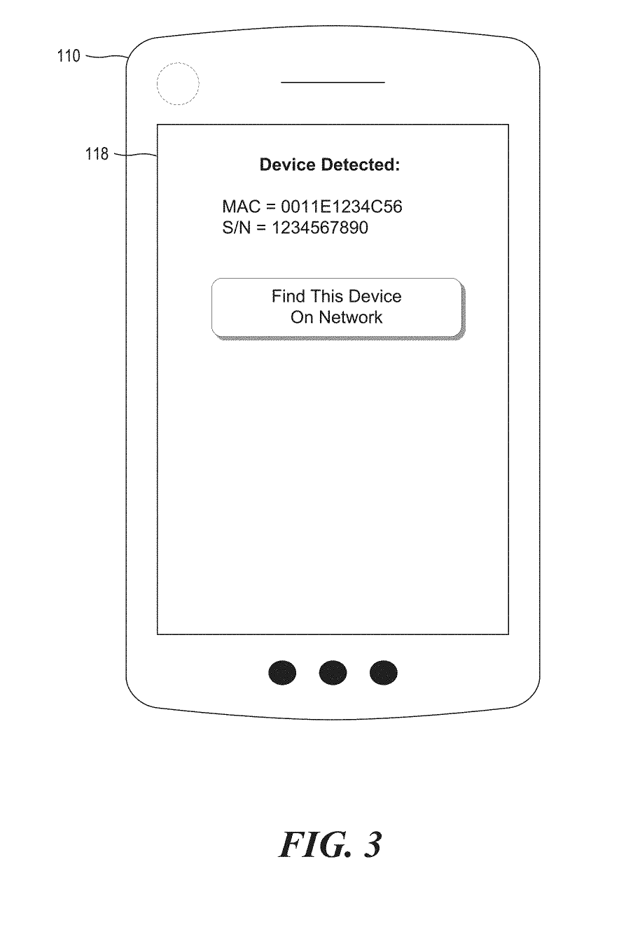

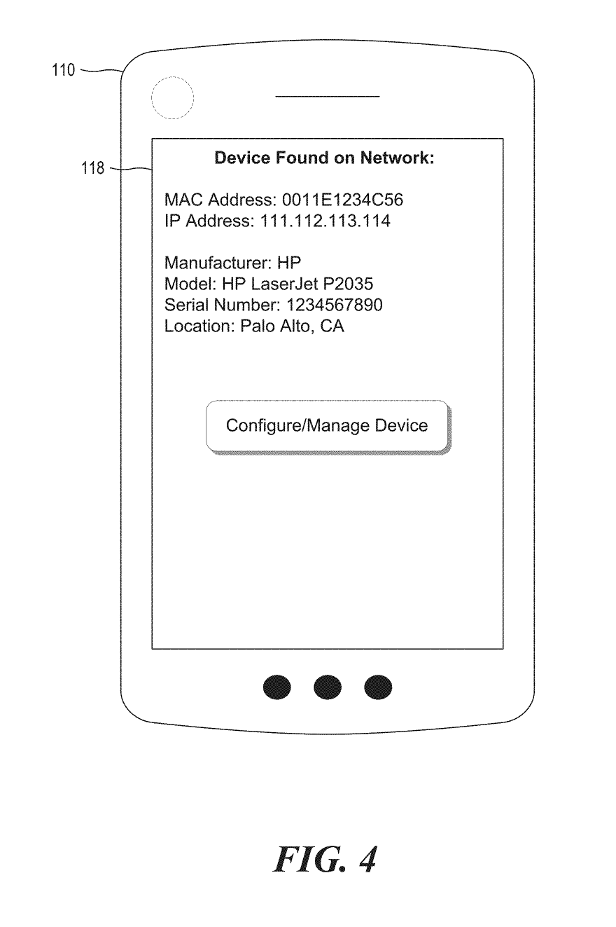

Alternatively, as illustrated in the example of FIG. 3, after automatically detecting the identifier(s) of network device 150, computing device 110 may display the identifier(s) on display 118 and then wait for the user's instruction to proceed to finding the device on the network, that is, finding the device's network address. When such instruction is received, computing device may find network device 150 on the network as described above, communicate with network device 150 to obtain its device information, and display that information on display 118, as illustrated in the example of FIG. 4. Computing device 110 may then provide the user with the option of updating some device information, adding additional information (e.g., a geographical location), or configuring or otherwise managing network device 150.

In the foregoing discussion, engines 112 and 114 were described as any combinations of hardware and programming. Such components may be implemented in a number of fashions. The programming may be processor executable instructions stored on a tangible, non-transitory computer-readable medium and the hardware may include a processing resource for executing those instructions. The processing resource, for example, may include one or multiple processors (e.g., central processing units (CPUs), semiconductor-based microprocessors, graphics processing units (GPUs), field-programmable gate arrays (FPGAs) configured to retrieve and execute instructions, or other electronic circuitry), which may be integrated in a single device or distributed across devices. The computer-readable medium can be said to store program instructions that when executed by the processor resource implement the functionality of the respective component. The computer-readable medium may be integrated in the same device as the processor resource or it may be separate but accessible to that device and the processor resource. In one example, the program instructions can be part of an installation package that when installed can be executed by the processor resource to implement the corresponding component. In this case, the computer-readable medium may be a portable medium such as a CD, DVD, or flash drive or a memory maintained by a server from which the installation package can be downloaded and installed. In another example, the program instructions may be part of an application or applications already installed, and the computer-readable medium may include integrated memory such as a hard drive, solid state drive, or the like. In another example, the engines 112 and 114 may be implemented by hardware logic in the form of electronic circuitry, such as application specific integrated circuits.

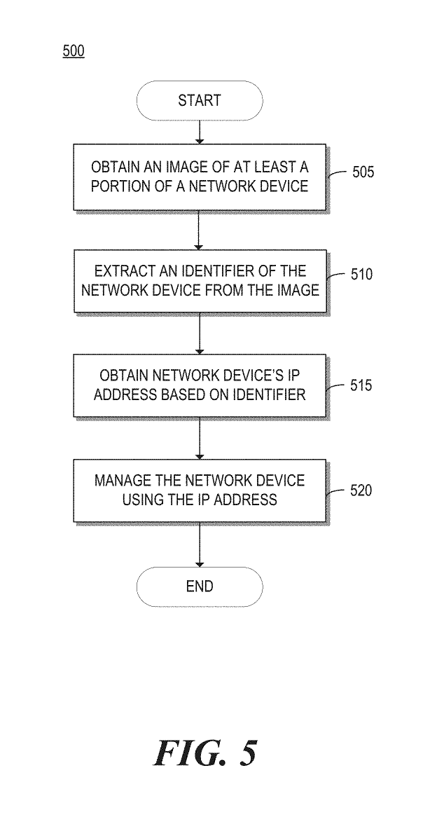

FIG. 5 is a flowchart of an example method 500 for automatically finding a network device on a network. Method 500 may be described below as being executed or performed by a system or by a computing device such as computing system 110 of FIG. 1. Other suitable systems and/or computing devices may be used as well. Method 500 may be implemented in the form of executable instructions stored on at least one non-transitory machine-readable storage medium of the system and executed by at least one processor of the system. Alternatively or in addition, method 500 may be implemented in the form of electronic circuitry (e.g., hardware). In alternate examples of the present disclosure, one or more blocks of method 500 may be executed substantially concurrently or in a different order than shown in FIG. 5. In alternate examples of the present disclosure, method 500 may include more or less blocks than are shown in FIG. 5. In some examples, one or more of the blocks of method 500 may, at certain times, be ongoing and/or may repeat.

At block 505, method 500 may obtain an image representing at least a portion of a network device (e.g., network device 150) connected to a network (e.g., network 170). At block 510, the method may extract from the image an identifier of the network device. As described above, the identifier may be, for example, a MAC address or a serial number of the network device. In some examples the identifier may be represented on the portion of the network device in a form of an alphanumerical value, a barcode, a QR code, or any combination of these and other types of representation. At block 515, the method may connect to the network to obtain a network address (e.g., an IP address) of the network device based on the identifier. For example, as discussed above, obtaining the network address based on the identifier may include querying a server (e.g., a DHCP server) connected to the network. In some examples, the server may include a database of identifiers (e.g., MAC addresses) and network addresses (e.g., IP addresses) associated therewith. Alternatively or additionally, obtaining the network address may include querying a plurality of network devices connected to the network, as discussed above. At block 520, the method may manage the network device through the network using the obtained IP address, as discussed above.

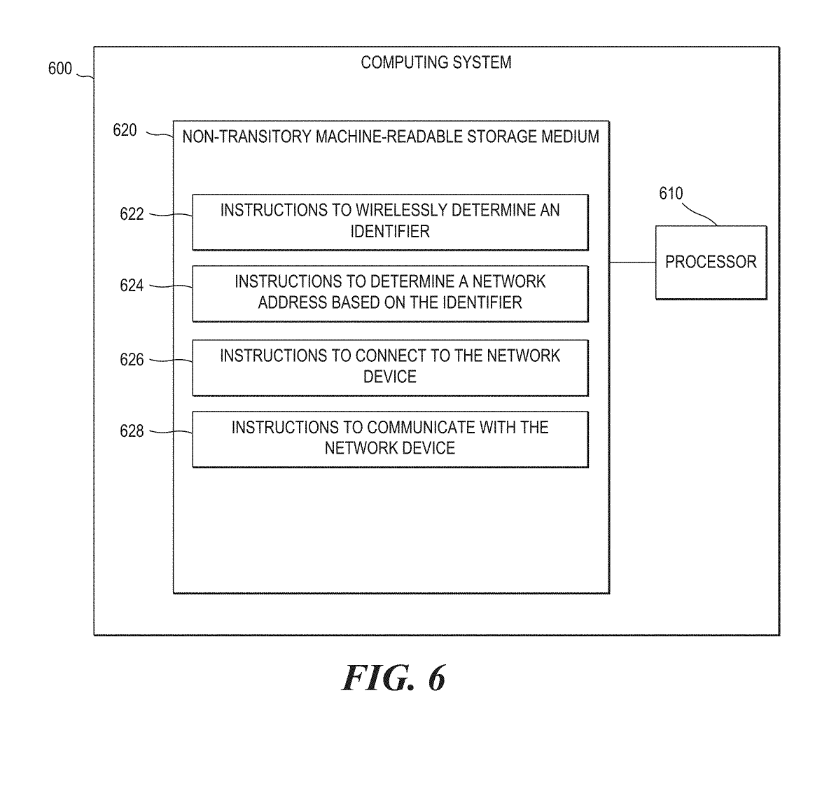

FIG. 6 is a block diagram of an example computing device 600 for automatically finding a network device on a network. Computing device 600 may be similar to computing device 110 of FIG. 1. In the example of FIG. 6, computing device 600 includes a processor 610 and a non-transitory machine-readable storage medium 620. Although the following descriptions refer to a single processor and a single machine-readable storage medium, it is appreciated that multiple processors and multiple machine-readable storage mediums may be anticipated in other examples. In such other examples, the instructions may be distributed (e.g., stored) across multiple machine-readable storage mediums and the instructions may be distributed (e.g., executed by) across multiple processors.

Processor 610 may be one or more central processing units (CPUs), microprocessors, and/or other hardware devices suitable for retrieval and execution of instructions stored in non-transitory machine-readable storage medium 620. In the particular example shown in FIG. 6, processor 610 may fetch, decode, and execute instructions 622, 624, 626, 628, or any other instructions (not shown for brevity) to generate one or more reports. As an alternative or in addition to retrieving and executing instructions, processor 610 may include one or more electronic circuits comprising a number of electronic components for performing the functionality of one or more of the instructions in machine-readable storage medium 620. With respect to the executable instruction representations (e.g., boxes) described and shown herein, it should be understood that part or all of the executable instructions and/or electronic circuits included within one box may, in alternate examples, be included in a different box shown in the figures or in a different box not shown.

Non-transitory machine-readable storage medium 620 may be any electronic, magnetic, optical, or other physical storage device that stores executable instructions. Thus, medium 620 may be, for example, Random Access Memory (RAM), an Electrically-Erasable Programmable Read-Only Memory (EEPROM), a storage drive, an optical disc, and the like. Medium 620 may be disposed within computing device 600, as shown in FIG. 6. In this situation, the executable instructions may be “installed” on computing device 600. Alternatively, medium 620 may be a portable, external or remote storage medium, for example, that allows computing device 600 to download the instructions from the portable/external/remote storage medium. In this situation, the executable instructions may be part of an “installation package”. As described herein, medium 620 may be encoded with executable instructions for finding a network device on a network.

Referring to FIG. 6, instructions 622, when executed by a processor (e.g., 610), may cause a computing device (e.g., 600) to wirelessly determine an identifier of a network device that is connected to a network and associated with an unknown network address, as discussed above. As discussed above, wirelessly determining the identifier may include capturing an image of at least a portion of the network device and/or using RF identification process.

Instructions 624, when executed by a processor, may cause a computing device to determine the unknown network address based on the identifier. As discussed above, this may include accessing a DHCP server and/or accessing the network device itself.

Instructions 626, when executed by a processor, may cause a computing device to connect to the network device through the network using the determined network address. Instructions 628, when executed by a processor, may cause a computing device to communicate with the network device. As discussed above, the communication may include receiving device information associated with the network device and/or sending configuration information for configuring the network device.

1. A computing device comprising:
a detection engine to wirelessly detect an identifier of a network device communicatively coupled to a network; and
a communication engine to:
access the network to obtain, based on the identifier, a network address associated with the network device, and
communicate with the network device through the network using the network address.

2. The computing device of claim 1, wherein the network address comprises an Internet Protocol (IP) address.

3. The computing device of claim 1, wherein communicating with the network device comprises at least one of:
receiving device information associated with the network device; and
configuring the network device.

4. The computing device of claim 1, further comprising an image sensor to capture an image of at least a portion of the network device, wherein the detection engine is to detect the identifier based at least on the image.

5. The computing device of claim 4, wherein the identifier is visually represented on a face of the network device by at least one of: a barcode, a quick-response code, and an alphanumerical value.

6. The computing device of claim 1, wherein the detection engine is to detect the identifier using a radio-frequency (RF) communication with the network device.

7. The computing device of claim 1, wherein the network comprises a dynamic host configuration protocol (DHCP) server, and wherein obtaining the network address comprises accessing the DHCP server.

8. The computing device of claim 1, wherein obtaining the network address comprises sending a plurality of queries to a plurality of network addresses and receiving, in response to least one of the plurality of queries, a response comprising the identifier.

9. A method comprising:
obtaining an image representing at least a portion of a network device connected to a network;
extracting from the image an identifier of the network device;
connecting to the network to obtain an internet protocol (IP) address of the network device based on the identifier; and
managing the network device through the network using the obtained IP address.

10. The method of claim 9, wherein the identifier is represented on the portion of the network device in a form of at least one of an alphanumerical value, a bar code, and a quick response (QR) code.

11. The method of claim 9, wherein the identifier comprises at least one of a Media Access Control (MAC) address and a serial number of the network device.

12. The method of claim 9, wherein obtaining the IP address of the network device comprises at least one of i) querying a server connected to the network, the server comprising a database of a plurality of identifiers associated with a plurality of IP addresses, and ii) querying a plurality of network devices connected to the network.

13. A non-transitory machine-readable storage medium encoded with instructions executable by at least one processor of at least one computing device to cause the computing device to:
wirelessly determine an identifier of a network device, wherein the network device is connected to a network and is associated with an unknown network address;
based on the identifier, determine the unknown network address;
connect to the network device through the network using the determined network address; and
communicate with the network device, wherein the communication comprises at least one of receiving device information associated with the network device and sending configuration information for configuring the network device.

14. The non-transitory machine-readable storage medium of claim 13, wherein wirelessly determining the identifier comprises at least one of capturing an image of at least a portion of the network device and using radio-frequency identification (RFID).

15. The non-transitory machine-readable storage medium of claim 13, wherein determining the network address comprises accessing at least one of a dynamic host configuration protocol (DHCP) server associated with the network and the network device.
